(19) United States
(12) Patent Application Publication
(10) Pub. No.: US 2025/0167335 A1
(43) Pub. Date: May 22, 2025

(54) BATTERY MODULE AND METHOD OF COOLING BATTERY

(71) Applicant: SK ON CO., LTD., Seoul (KR)

(72) Inventor: Jong Hyuk LEE, Daejeon (KR)

(21) Appl. No.: 18/951,653

(22) Filed: Nov. 19, 2024

(30) Foreign Application Priority Data
Nov. 22, 2023 (KR) 10-2023-0163193

(51) Int. Cl. H01M 10/633; H01M 10/42; H01M 10/48; H01M 10/613; H01M 10/647; H01M 10/6557; H01M 50/178; H01M 50/211

(52) U.S. Cl. CPC H01M 10/633; H01M 10/425; H01M 10/482; H01M 10/486; H01M 10/613; H01M 10/647; H01M 10/6557; H01M 50/178; H01M 50/211; H01M 2010/4271; H01M 2200/10

(57) ABSTRACT

A battery module is disclosed. The battery module according to the present disclosure includes a battery cell assembly including a plurality of battery cells stacked in a front-rear direction, a case configured to accommodate the battery cell assembly, and a cooling unit accommodated in the case and including a cooling bus. The cooling bus includes a cooling bus body that is accommodated in the case and extends in a direction in which the plurality of battery cells are stacked.

### CROSS-REFERENCE TO RELATED APPLICATION AND CLAIM OF PRIORITY

This application claims priority to Korean Patent Application No. 10-2023-0163193 filed on Nov. 22, 2023 in the Korean Intellectual Property Office (KIPO), the entire disclosure of which is incorporated by reference herein.

### TECHNICAL FIELD

The present disclosure relates to a battery module.

### BACKGROUND

The operating performance of a battery may vary depending on its temperature. Therefore, it is necessary to maintain the temperature of the battery at an appropriate level. For example, if the battery overheats, heat generated from the battery needs to be effectively discharged to the outside. In addition, if a fire occurs in a battery cell, it is necessary to actively extinguish the fire.

### SUMMARY

An object of the present disclosure is to address the above-described and other problems.

Another object of the present disclosure is to provide a battery module and a battery cooling method for directly applying a coolant to battery cells.

Another object of the present disclosure is to provide a battery module and a battery cooling method for controlling a temperature of a battery cell based on the temperature of the battery cell.

In order to achieve the above-described and other objects and needs, in one aspect of the present disclosure, there may be provided a battery module comprising a battery cell assembly including a plurality of battery cells stacked in a front-rear direction; a case configured to accommodate the battery cell assembly; and a cooling unit accommodated in the case, the cooling unit including a cooling bus, wherein the cooling bus includes a cooling bus body that is accommodated in the case and extends in a direction in which the plurality of battery cells are stacked.

In another aspect of the present disclosure, there may be provided a battery pack comprising at least one battery module; a battery management module connected to the at least one battery module; and a cooling module including a cooling tank containing a coolant, wherein the at least one battery module includes a battery cell assembly including a plurality of battery cells stacked in a front-rear direction; a case configured to accommodate the battery cell assembly; and a cooling unit accommodated in the case, the cooling unit including a cooling bus, wherein the cooling bus includes a cooling bus body that is accommodated in the case and receives the coolant from the cooling module, and wherein the cooling bus body extends in a direction in which the plurality of battery cells are stacked.

In another aspect of the present disclosure, there may be provided a battery cooling method of cooling a plurality of battery cells comprising measuring a first temperature of the plurality of battery cells; comparing the first temperature with a first reference temperature; when the first temperature is greater than or equal to the first reference temperature, injecting a coolant into the plurality of battery cells; measuring a second temperature of the plurality of battery cells; comparing the second temperature with a second reference temperature; and stopping injecting the coolant when the second temperature is less than or equal to the second reference temperature.

Effects of a battery module according to the present disclosure are described as follows.

According to at least one aspect of the present disclosure, there can be provided a battery module and a battery cooling method for directly applying a coolant to a battery cell.

According to at least one aspect of the present disclosure, there can be provided a battery module and a battery cooling method for controlling a temperature of a battery cell based on the temperature of the battery cell.

A battery module and a battery cooling method according to some embodiments of the present disclosure can be used in eco-friendly electric vehicles, hybrid vehicles, etc. to prevent climate change by suppressing air pollution and greenhouse gas emissions.

### BRIEF DESCRIPTION OF THE DRAWINGS

The accompanying drawings, which are included to provide a further understanding of the disclosure and are incorporated in and constitute a part of the disclosure, illustrate embodiments of the disclosure and together with the description serve to explain the principle of the disclosure.

FIG. 1 illustrates a battery module according to an embodiment of the present disclosure.

FIG. 2 is an exploded perspective view of a battery module illustrated in FIG. 1.

FIG. 3 illustrates a battery cell assembly illustrated in FIG. 2.

FIG. 4 illustrates a battery cell according to an embodiment of the present disclosure.

FIG. 5 illustrates a cross section of a battery cell illustrated in FIG. 4 taken along A1-A2.

FIG. 6 illustrates a cooling unit according to an embodiment of the present disclosure.

FIG. 7 is a side view of a battery module according to an embodiment of the present disclosure.

FIG. 8 illustrates a cross section of a battery module illustrated in FIG. 7 taken along B1-B2.

FIG. 9 illustrates a cooling leg according to an embodiment of the present disclosure.

FIG. 10 illustrates a cooling leg with a colling region.

FIG. 11 illustrates a cooling unit in which a nozzle is formed on a cooling bus.

FIG. 12 illustrates a cross section of a cooling bus illustrated in FIG. 11 taken along C1-C2.

FIG. 13 is a block diagram of a battery module according to an embodiment of the present disclosure.

FIG. 14 schematically illustrates a battery pack according to an embodiment of the present disclosure.

FIG. 15 is a block diagram of a battery pack according to an embodiment of the present disclosure.

FIG. 16 is a flowchart illustrating a battery cooling method according to an embodiment of the present disclosure.

### DETAILED DESCRIPTION OF THE EMBODIMENTS

Reference will now be made in detail to embodiments of the present disclosure, examples of which are illustrated in the accompanying drawings. However, the following description is merely an example and does not intend to limit the present disclosure to a specific implementation.

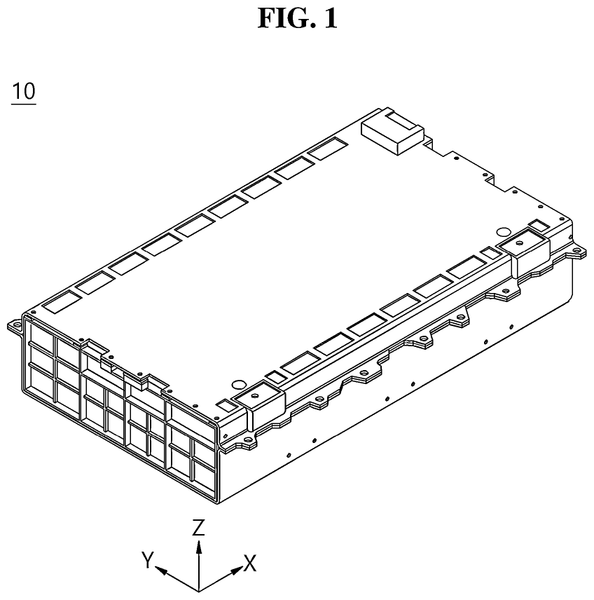

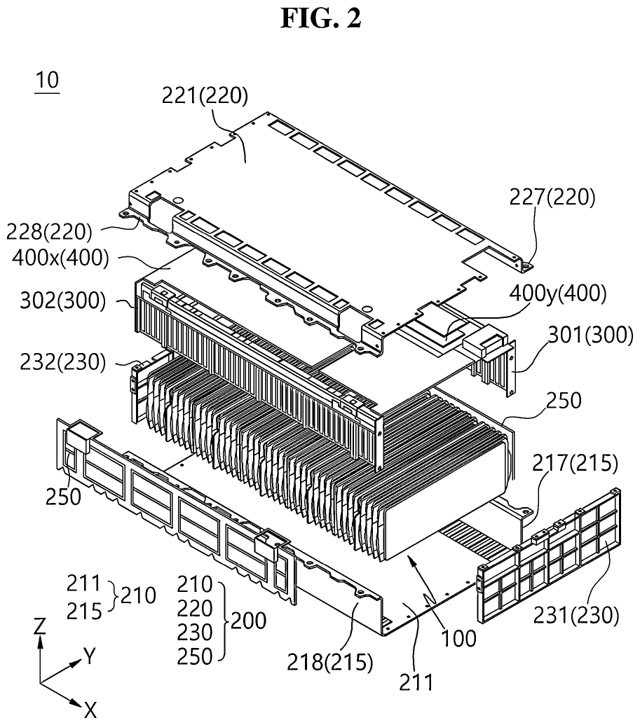

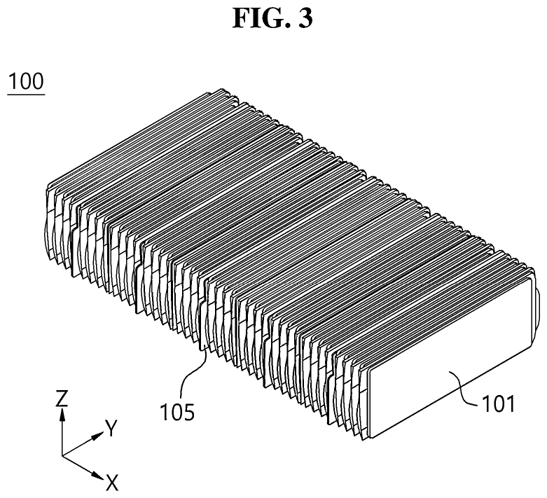

FIG. 1 illustrates a battery module 10 according to an embodiment of the present disclosure. FIG. 2 is an exploded perspective view of the battery module 10 illustrated in FIG. 1. FIG. 3 illustrates a battery cell assembly illustrated in FIG. 2.

In the present disclosure, a coordinate system may be a cartesian coordinate system. In the present disclosure, an up-down direction and a front-rear direction may be set based on FIG. 2.

For example, the front-rear direction may be parallel to the X-axis. For example, the X-axis may indicate the forward. For example, the up-down direction may be parallel to the Z-axis. For example, the Z-axis may indicate the upward. The Y-axis may be perpendicular to both the X-axis and the Z-axis.

Referring to FIGS. 1 to 3, the battery module 10 may include a battery cell assembly 100. The battery cell assembly 100 may include a plurality of battery cells 101. The plurality of battery cells 101 may be arranged or stacked in one direction.

For example, a direction in which the plurality of battery cells 101 are arranged or stacked may be a longitudinal direction or a length direction of the battery module 10. The longitudinal direction of the battery module 10 may be the front-rear direction.

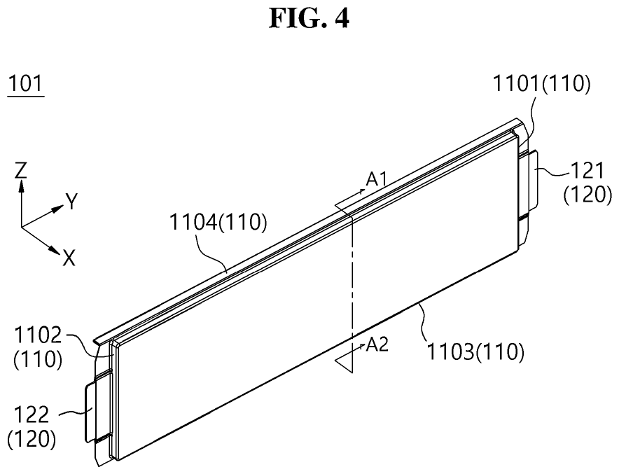

Each of the plurality of battery cells 101 may include a battery cell body 110 (see FIG. 4). The battery cell body 110 (see FIG. 4) may extend from one end and lead to another end. The one end of the battery cell body 110 (see FIG. 4) may be referred to as a “first end” of the battery cell body 110 (see FIG. 4). The another end of the battery cell body 110 (see FIG. 4) may be referred to as a “second end” of the battery cell body 110 (see FIG. 4).

For example, the battery cell body 110 (see FIG. 4) may form a shape that extends in a width direction or a transverse direction of the battery module 10. In other words, a longitudinal direction or a length direction of the battery cell body 110 (see FIG. 4) may be the width direction or the transverse direction of the battery module 10.

Each of the plurality of battery cells 101 may include an electrode lead 120 (see FIG. 4). The electrode lead 120 (see FIG. 4) may form a shape extending from the battery cell body 110 (see FIG. 4).

For example, the electrode lead 120 (see FIG. 4) may form a shape protruding from the battery cell body 110 (see FIG. 4). For example, the electrode lead 120 (see FIG. 4) may include a first electrode lead 121 (see FIG. 4) protruding from a first end of the battery cell body 110 (see FIG. 4). For example, the electrode lead 120 (see FIG. 4) may include a second electrode lead 122 (see FIG. 4) protruding from a second end of the battery cell body 110 (see FIG. 4).

The battery cell assembly 100 may include a pad 105. The pad 105 may be disposed between the plurality of battery cells 101. When thermal runaway occurs in one battery cell 101 of the plurality of battery cells 101, the pad 105 can prevent heat or flame from the battery cell 101, in which the thermal runaway occurs, from moving to the surrounding battery cells 101. The pad 105 may include a heat-resistant material. In this context, the pad 105 may be referred to as a “heat blocking pad.”

The battery module 10 may include a case 200. The case 200 may be referred to as a “battery case.” The case 200 may include a first case 210. The first case 210 may accommodate the battery cell assembly 100.

The first case 210 may include a bottom case 211. The bottom case 211 may form the bottom of the case 200. The bottom case 211 may be positioned below the battery cell assembly 100.

In other words, the battery cell assembly 100 may be loaded on the bottom case 211. The bottom case 211 may form a plate shape. The bottom case 211 may be referred to as a “bottom plate.”

The bottom plate 211 may include four edges (or sides). The four edges of the bottom plate 211 may form a perimeter of the bottom plate 211. Two connection edges of the bottom plate 211 may be two edges extending along the longitudinal direction of the battery module 10 among the four edges of the bottom plate 211.

A “first connection edge” of the bottom plate 211 may be a connection edge adjacent to the first end of the battery cell body among the two connection edges of the bottom plate 211. The “first connection edge” of the bottom plate 211 may extend rearward from an end of a front edge of the bottom plate 211 and lead to an end of a rear edge of the bottom plate 211.

A “second connection edge” of the bottom plate 211 may be a connection edge adjacent to the second end of the battery cell body among the two connection edges of the bottom plate 211. The “second connection edge” of the bottom plate 211 may extend rearward from another end of the front edge of the bottom plate 211 and lead to another end of the rear edge of the bottom plate 211.

The first connection edge and the second connection edge of the bottom plate 211 may be parallel to each other.

The first case 210 may include a side case 215. The side case 215 may be formed by extending upward from the bottom plate 211. The side case 215 may be formed integrally with the bottom plate 211.

A plurality of side cases 215 may be provided. For example, the side case 215 may include a first side case 217 formed by extending upward from the first connection edge of the bottom plate 211.

For example, the side case 215 may include a second side case 218 formed by extending upward from the second connection edge of the bottom plate 211. The second side case 218 may face the first side case 217. A direction from the first side case 217 toward the second side case 218 may be parallel to the transverse direction of the battery module 10.

The case 200 may include a second case 220. The second case 220 may include a top case 221. The top case 221 may be formed of a material including a metal. The top case 221 may be referred to as a “top cover.”

The top case 221 may include four edges (or sides). The four edges of the top case 221 may form a perimeter of the top case 221. Two connection edges (or connection sides) of the top case 221 may be two edges extending along the longitudinal direction of the battery module 10 among the four edges of the top case 221.

A “first connection edge” of the top case 221 may be a connection edge adjacent to the first end of the battery cell body among the two connection edges of the top case 221. A “second connection edge” of the top case 221 may be a connection edge adjacent to the second end of the battery cell body among the two connection edges of the top case 221. The first connection edge and the second connection edge may be parallel to each other.

The second case 220 may include wing cases 227 and 228. The wing cases 227 and 228 may be formed integrally with the top case 221. The wing cases 227 and 228 may be formed by extending downward from the edge of the top case 221.

For example, the wing cases 227 and 228 may include a first wing case 227 formed by extending downward from the first connection edge of the top case 221. For example, the wing cases 227 and 228 may include a second wing case 228 formed by extending downward from the second connection edge of the top case 221.

The wing cases 227 and 228 may be coupled or fastened to the side case 215. For example, the first wing case 227 may be coupled or fastened to the first side case 217. For example, the second wing case 228 may be coupled or fastened to the second side case 218.

The case 200 may include a front and rear case 230. The front and rear cases 230 may include a front case 231. The front case 231 may face the battery cell assembly 100. The front case 231 may be positioned in front of the battery cell assembly 100.

The front case 231 may be connected or coupled to a front end of the first side case 217. The front case 231 may be connected or coupled to a front end of the second side case 218. The front case 231 may be connected or coupled to a front end of the bottom case 211. The front case 231 may be referred to as a “first cover plate.”

The front and rear cases 230 may include a rear case 232. The rear case 232 may face the battery cell assembly 100. The rear case 232 may be positioned behind the battery cell assembly 100.

The rear case 232 may be connected or coupled to a rear end of the first side case 217. The rear case 232 may be connected or coupled to a rear end of the second side case 218. The rear case 232 may be connected or coupled to a rear end of the bottom case 211. The rear case 232 may be referred to as a “second cover plate.”

The front and rear case 230 may be referred to as a “cover plate”. The cover plate 230 may indicate at least one of the first cover plate 231 and the second cover plate 232.

The case 200 may include an insulating cover 250. The insulating cover 250 may be disposed between the battery cell assembly 100 and the side case 215. The insulating cover 250 may include an insulating material.

The battery module 10 may include a busbar unit 300. The busbar unit 300 may be electrically connected to the battery cell assembly 100. The busbar unit 300 may be disposed between the battery cell assembly 100 and the case 200. The busbar unit 300 may electrically connect the plurality of battery cells 101. A plurality of busbar units 300 may be provided.

For example, the busbar unit 300 may include a first busbar unit 301 positioned between the first side case 217 and the battery cell assembly 100. The first busbar unit 301 may electrically connect the first electrode leads 121 (see FIG. 4) of the plurality of battery cells 101.

For example, the busbar unit 300 may include a second busbar unit 302 positioned between the second side case 218 and the battery cell assembly 100. The second busbar unit 302 may electrically connect the second electrode leads 122 (see FIG. 4) of the plurality of battery cells 101.

The battery module 10 may include a sensing unit 400. The sensing unit 400 may include a sensing frame 400x. The sensing frame 400x may connect the first busbar unit 301 to the second busbar unit 302.

The sensing frame 400x may be positioned between the battery cell assembly 100 and the top case 221. The sensing frame 400x may form a plate or board shape.

The sensing unit 400 may include a battery sensor 400y. The battery sensor 400y may be connected or fixed to the sensing frame 400x. The battery sensor 400y may be connected to the busbar unit 300.

For example, the battery sensor 400y may be electrically connected to the busbar unit 300. For example, the battery sensor 400y may be electrically connected to the first busbar unit 301 and electrically connected to the second busbar unit 302.

For example, the battery sensor 400y may obtain a signal from the busbar unit 300. For example, the battery sensor 400y may obtain an electric signal from the busbar unit 300. The electric signal obtained by the battery sensor 400y may be a current or a voltage. Hence, the battery sensor 400y may obtain information on charge/discharge state of the battery cell assembly 100.

For example, the battery sensor 400y may include a temperature sensor. For example, the temperature sensor included in the battery sensor 400y may obtain temperature information of the battery cell assembly 100.

The battery sensor 400y may be connected to an external device. For example, the battery sensor 400y may be connected to a battery management system (BMS). For example, the battery sensor 400y may transmit information on the battery cell assembly 100 to the BMS. The information on the battery cell assembly 100 may include at least one of the information on the charge/discharge state of the battery cell assembly 100 and the information on the temperature of the battery cell assembly 100.

The battery module 10 may include a cooling unit 500. A plurality of cooling units 500 may be provided. For example, the battery module 10 may include a plurality of cooling units 501 and 502. For example, the battery module 10 may include a first cooling unit 501 and a second cooling unit 502. For example, the cooling unit 500 may include or indicate at least one of the first cooling unit 501 and the second cooling unit 502.

The first cooling unit 501 may be adjacent to the first busbar unit 301. For example, the first cooling unit 501 may be positioned between the first busbar unit 301 and the battery cell body 110 (see FIG. 4) of the plurality of battery cells 101.

The second cooling unit 502 may be adjacent to the second busbar unit 302. For example, the second cooling unit 502 may be positioned between the second busbar unit 302 and the battery cell body 110 (see FIG. 4) of the plurality of battery cells 101.

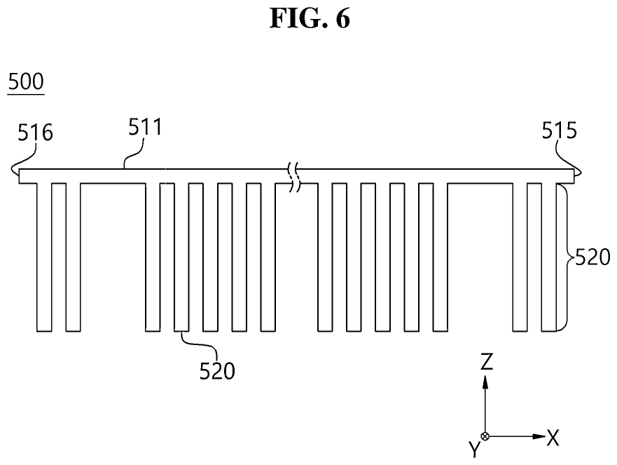

A cooling bus 510 (see FIG. 6) of the cooling unit 500 may form a shape extending in the direction in which the plurality of battery cells 101 are stacked. Each of a plurality of cooling legs 520 (see FIG. 6) of the cooling unit 500 may be disposed between the electrode leads 120 (see FIG. 4) of two adjacent battery cells 101 corresponding to each cooling leg 520.

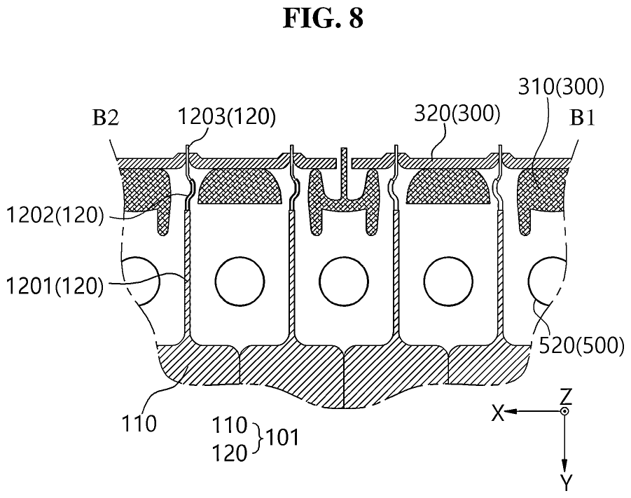

For example, each of the plurality of cooling legs 520 (see FIG. 6) of the cooling unit 500 may be positioned between electrode lead terraces 1201 (see FIG. 8) of two adjacent battery cells 101 corresponding to each cooling leg 520.

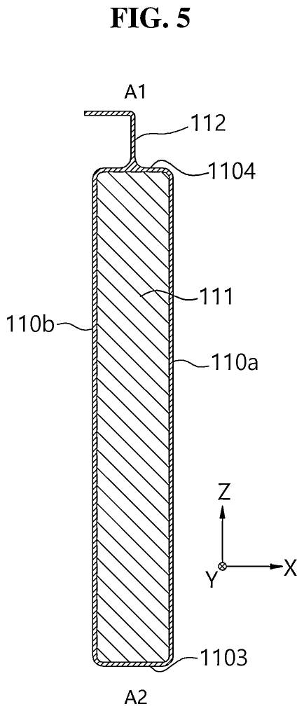

FIG. 4 illustrates a battery cell according to an embodiment of the present disclosure. FIG. 5 illustrates a cross section of a battery cell illustrated in FIG. 4 taken along A1-A2.

Referring to FIGS. 4 and 5, the battery cell assembly 100 (see FIG. 3) may include the plurality of battery cells 101. The battery cell 101 may include the battery cell body 110.

The battery cell body 110 may form an extended or elongated shape in a longitudinal direction of the battery cell body 110. For example, the longitudinal direction of the battery cell body 110 may be a width direction of the battery module 10.

The battery cell body 110 may form a thickness direction. For example, the thickness direction of the battery cell body 110 may be a thickness direction of the battery cell 101. For example, the thickness direction of the battery cell body 110 may be a direction in which a plurality of battery cells 101 are stacked.

For example, the thickness direction of the battery cell body 110 may be the front-rear direction. For example, the thickness direction of the battery cell body 110 may be the length direction or longitudinal direction of the battery module 10 (see FIGS. 1 and 2).

The battery cell body 110 may form two faces in the thickness direction. For example, the battery cell body 110 may include a cell body front face 110a and a cell body rear face 110b.

The cell body front face 110a may form a front face of the battery cell body 110. The cell body rear face 110b may form a rear face of the battery cell body 110. In two adjacent battery cells 101, the cell body front face 110a of the latter battery cell 101 may face or contact the cell body rear face 110b of the former battery cell 101.

The battery cell body 110 may form a perimeter. For example, a face or surface having, as a width, a thickness of the battery cell body 110 may be formed along the perimeter of the battery cell body 110. The thickness direction of the battery cell body 110 may be parallel to the direction in which the plurality of battery cells 101 are stacked.

For example, the battery cell body 110 may include a lower cell body edge face 1103 forming a lower face of the battery cell body 110. The lower cell body edge face 1103 may be elongated along a lower side (or edge) of the battery cell body 110. A width of the lower cell body edge face 1103 may correspond to the thickness of the battery cell body 110. The lower cell body edge face 1103 may face or contact the bottom case 211.

For example, the battery cell body 110 may include an upper cell body edge face 1104 forming an upper face of the battery cell body 110. The upper cell body edge face 1104 may be elongated along an upper side of the battery cell body 110. A width of the upper cell body edge face 1104 may correspond to the thickness of the battery cell body 110. The upper cell body edge face 1104 may face or contact the top case 221.

A width direction of the battery cell body 110 may be defined. For example, the width direction of the battery cell body 110 may be parallel to a longitudinal direction of a busbar slit 322. For example, the width direction of the battery cell body 110 may be the up-down direction, referring to the drawing.

The width direction of the battery cell body 110 may intersect the longitudinal direction and the thickness direction of the battery cell body 110. For example, the width direction of the battery cell body 110 may be perpendicular to each of the longitudinal direction and the thickness direction of the battery cell body 110.

For example, the battery cell body 110 may include a first cell body edge face 1101 facing the first busbar unit 301 (see FIG. 2). The first cell body edge face 1101 may extend upward from a first end of the lower cell body edge face 1103 and lead to a first end of the upper cell body edge face 1104. A width of the first cell body edge face 1101 may correspond to the thickness of the battery cell body 110.

For example, the battery cell body 110 may include a second cell body edge face 1102 facing the second busbar unit 302 (see FIG. 2). The second cell body edge face 1102 may extend upward from a second end of the lower cell body edge face 1103 and lead to a second end of the upper cell body edge face 1104. A width of the second cell body edge face 1102 may correspond to the thickness of the battery cell body 110.

The battery cell 101 may include an electrode assembly 111. The electrode assembly 111 may be a part of the battery cell body 110. The electrode assembly 111 may be referred to as a jelly-roll.

The battery cell 101 may include an exterior material 112. For example, the exterior material 112 may include a pouch with a sheet shape. The exterior material 112 may accommodate the electrode assembly 111. For example, the exterior material 112 may be sealed to accommodate the electrode assembly 111 therein. The exterior material 112 may be another part of the battery cell body 110.

The battery cell 101 may include the electrode lead 120. The electrode lead 120 may extend from the electrode assembly 111. The electrode lead 120 may protrude from the battery cell body 110. For example, at least a portion of the electrode lead 120 may be surrounded by the outer material 112.

The electrode lead 120 may protrude in the longitudinal direction of the battery cell body 110. For example, the electrode lead 120 may include the first electrode lead 121 protruding from the first cell body edge face 1101 of the battery cell body 110. For example, the electrode lead 120 may include the second electrode lead 122 protruding from the second cell body edge face 1102 of the battery cell body 110.

The longitudinal direction of the battery cell body 110 may be parallel to a direction from the first electrode lead 121 to the second electrode lead 122. The longitudinal direction of the battery cell body 110 may be parallel to a direction from the first cell body edge face 1101 to the second cell body edge face 1102. The longitudinal direction of the battery cell 101 may be the longitudinal direction of the battery cell body 110.

The width direction of the battery cell body 110 may be parallel to a direction from the lower cell body edge face 1103 to the upper cell body edge face 1104. The width direction of the battery cell body 110 may be the up-down direction. The width direction of the battery cell 101 may be the width direction of the battery cell body 110.

The thickness direction of the battery cell body 110 may be parallel to a direction from the cell body front face 110a to the cell body rear face 110b. The thickness direction of the battery cell 101 may be the thickness direction of the battery cell body 110.

The outer material 112 may form two surfaces when unfolded. For example, the outer material 112 may form an outer material inner surface and an outer material outer surface. In a state in which the outer material 112 accommodates the electrode assembly 111 and is sealed, the inner surface of the outer material 112 may face the electrode assembly 111, and the outer surface of the outer material 112 may form an outer surface of the battery cell body 110.

The outer material 112 may form an accommodation part that accommodates the electrode assembly 111 in the unfolded state.

For example, the accommodation part of the outer material 112 may include a front accommodation portion that accommodates a front portion of the electrode assembly 111. The front accommodation portion of the outer material 112 may form the cell body front face 110a.

For example, the accommodation part of the outer material 112 may include a rear accommodation portion that accommodates a rear portion of the electrode assembly 111. The rear accommodation portion of the outer material 112 may form the cell body rear face 110b.

The lower cell body edge face 1103 may connect the cell body front face 110a and the cell body rear face 110b. The lower cell body edge face 1103 may connect the front accommodation portion and the rear accommodation portion of the outer material 112. The lower cell body edge face 1103 of the outer material 112 may connect the front accommodation portion and the rear accommodation portion of the outer material 112. In this context, the lower cellbody edge face 1103 of the outer material 112 may be referred to as a “connection portion.”

The lower cell body edge face 1103 of the outer material 112 may face and contact the electrode assembly 111. For example, an inner surface of the lower cell body edge face 1103 of the outer material 112 may face and contact the electrode assembly 111. For example, an outer surface of the lower cell body edge face 1103 of the outer material 112 may be in contact with the bottom case 211 (see FIG. 2).

At least one of the upper cell body edge face 1104, the first cell body edge face 1101, or the second cell body edge face 1102 of the outer material 112 may be formed by overlapping and attaching sheets forming the outer material 112 to each other.

Therefore, the outer material 112 at the upper cell body edge face 1104, the first cell body edge face 1101, and the second cell body edge face 1102 may protrude to the outside of the battery cell body 110.

For this reason, the effect (or efficiency) of cooling the battery cell body 110 at the lower cell body edge face 1103 may be greater than the effect (or efficiency) of cooling the battery cell body 110 on at least one of the upper cell body edge face 1104, the first cell body edge face 1101, and the second cell body edge face 1102.

FIG. 6 illustrates a cooling unit according to an embodiment of the present disclosure.

Referring to FIG. 6, the cooling unit 500 may include the cooling bus 510. The cooling bus 510 may include a cooling bus body 511. The cooling bus body 511 may be accommodated in the case 200 (see FIG. 2). For example, the cooling bus body 511 may be installed or coupled to the case 200 (see FIG. 2).

For example, the cooling bus body 511 may be adjacent to the top case 221 (see FIG. 2). For example, the cooling bus body 511 may be adjacent to an upper end of the battery cell assembly 100 (see FIG. 2).

For another example, the cooling bus body 511 may be adjacent to the bottom case 211 (see FIG. 2). For example, the cooling bus body 511 may be adjacent to a lower end of the battery cell assembly 100 (see FIG. 2).

The cooling bus 510 may flow a coolant. For example, the cooling bus body 511 may be a passage through which the coolant flows. For example, the cooling bus body 511 may form a shape of a pipe forming a hollow portion.

The cooling bus 510 may include a coolant inlet 515 formed on one side of the cooling bus body 511. The coolant may be supplied to the cooling bus body 511 through the coolant inlet 515. For example, the coolant may be a fluid. For example, the coolant may be in the form of a liquid or a gas.

The cooling bus 510 may include a coolant outlet 516 formed on another side of the cooling bus body 511. The coolant from the cooling bus body 511 may be discharged to the outside of the case 200 (see FIG. 2) through the coolant outlet 516.

The cooling bus body 511 may be extended or elongated in one direction. For example, the cooling bus body 511 may be extended or elongated in the direction in which the plurality of battery cells 101 (see FIG. 3) are stacked.

For example, the cooling bus body 511 may be elongated to cross the plurality of battery cells 101 (see FIG. 3). For example, the cooling bus body 511 may be elongated to cross the electrode leads 120 (see FIG. 4) of the plurality of battery cells 101 (see FIG. 3).

For example, the cooling bus body 511 may extend rearward from a front end and lead to a rear end. For example, the coolant inlet 515 may be positioned at a front end of the cooling bus body 511, and the coolant outlet 516 may be positioned at a rear end of the cooling bus body 511. For another example, the coolant inlet 515 may be positioned at the rear end of the cooling bus body 511, and the coolant outlet 516 may be positioned at the front end of the cooling bus body 511.

The cooling unit 500 may include the cooling leg 520. The cooling leg 520 may extend or protrude from the cooling bus body 511. For example, the cooling leg 520 may extend or protrude downward from the cooling bus body 511. For another example, the cooling leg 520 may extend or protrude upward from the cooling bus body 511. An opening may be formed in the cooling leg 520.

A plurality of cooling legs 520 may be provided. For example, the cooling unit 500 may include a plurality of cooling legs 520. The plurality of cooling legs 520 may be arranged along the cooling bus body 511. The plurality of cooling legs 520 may be spaced apart from each other.

When the coolant is introduced into the cooling bus 510, the coolant may flow inside the cooling bus body 511. When the coolant is introduced into the cooling bus body 511, an internal pressure of the cooling bus body 511 may be greater than an internal pressure of the cooling legs 520. The coolant contained in the cooling bus body 511 may move to the cooling legs 520. The coolant introduced into the cooling legs 520 may be sprayed toward the battery cells 101 (see FIG. 4) through the openings formed in the cooling legs 520.

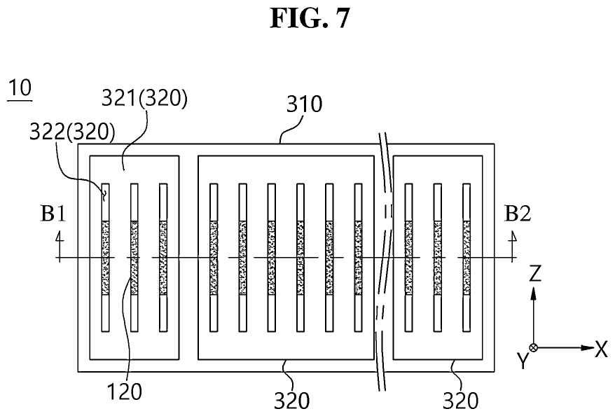

FIG. 7 is a side view of a battery module according to an embodiment of the present disclosure. In FIG. 7, the indication of the case 200 (see FIG. 2) may be omitted for convenience of explanation.

Referring to FIGS. 2 and 7, the busbar unit 300 may include a busbar 320. The busbar 320 may include a busbar plate 321. The busbar plate 321 may form a plate shape.

The busbar plate 321 may electrically connect at least two battery cells 101 (see FIG. 3). For example, the busbar plate 321 may be formed of a material including an electrically conductive material. For example, the busbar plate 321 may be formed of a material including a metal.

The busbar 320 may include a busbar slit 322. The busbar slit 322 may be formed in the busbar plate 321. For example, the busbar slit 322 may be elongated in the up-down direction.

The busbar 320 may be coupled to the electrode lead 120 (see FIG. 4). For example, the busbar plate 321 may be coupled to the electrode lead 120 (see FIG. 4). For example, the electrode lead 120 (see FIG. 4) may be inserted into the busbar slit 322 and coupled to the busbar plate 321. For example, the busbar plate 321 may be coupled to the electrode lead 120 (see FIG. 4) through welding.

A plurality of busbars 320 may be provided. For example, the busbar unit 300 may include the plurality of busbars 320. For example, the first busbar unit 301 (see FIG. 2) may include a plurality of busbars 320. For example, the second busbar unit 302 (see FIG. 2) may include a plurality of busbars 320.

For example, the busbars 320 included in the first busbar unit 301 (see FIG. 2) may be coupled to the first electrode leads 121 (see FIG. 4) of the plurality of battery cells 101 (see FIG. 3).

For example, the busbars 320 included in the second busbar unit 302 (see FIG. 2) may be coupled to the second electrode leads 122 (see FIG. 4) of the plurality of battery cells 101 (see FIG. 3).

For example, the plurality of busbars 320 included in the first busbar unit 301 (see FIG. 2) may be arranged in the front-rear direction. For example, the plurality of busbars 320 included in the second busbar unit 302 (see FIG. 2) may be arranged in the front-rear direction.

The busbar unit 300 may include a busbar support 310. The busbar support 310 may support the busbar 320. The busbar support 310 may be coupled to the busbar 320.

The busbar support 310 may be formed of a material including an insulating material. For example, the busbar support 310 may be formed of a material including a polymer material. The busbar support 310 may electrically isolate the two adjacent busbars 320.

The busbar support 310 may be extended or elongated in the direction in which the plurality of battery cells 101 (see FIG. 3) are stacked. For example, the busbar support 310 may be extended or elongated in the front-rear direction.

For example, the cooling leg 520 may extend from the cooling bus body 511 in a direction intersecting a longitudinal direction of the cooling bus body 511. For example, the cooling leg 520 may extend from the cooling bus body 511 in the width direction of the battery cell 101.

FIG. 8 illustrates a cross section of a battery module illustrated in FIG. 7 taken along B1-B2.

Referring to FIG. 8, the battery cell 101 may include the battery cell body 110. A plurality of battery cell bodies 110 may be stacked in one direction. For example, the plurality of battery cell bodies 110 may be stacked in the longitudinal direction of the battery cell 101 (see FIGS. 1 and 2).

The battery cell body 110 may face the busbar unit 300. For example, the battery cell body 110 may face the busbar support 310. For example, the first cell body edge face 1101 (see FIG. 4) or the second cell body edge face 1102 (see FIG. 4) of the battery cell body 110 may face the busbar support 310.

The electrode lead 120 may include the electrode lead terrace 1201. The electrode lead terrace 1201 may extend or protrude from the electrode assembly 111 (see FIG. 5) of the battery cell body 110. For example, the electrode lead terrace 1201 may extend or protrude from the electrode assembly 111 (see FIG. 5) of the battery cell body 110 toward the busbar 320.

An outer surface of the electrode lead terrace 1201 may be formed by the outer material 112 (see FIG. 5). The outer material 112 (see FIG. 5) may be electrically insulated. That is, the electrode lead terrace 1201 may be electrically insulated.

The electrode lead 120 may include an electrode lead extension 1202. The electrode lead extension 1202 may extend from the electrode lead terrace 1201. The electrode lead extension 1202 may be positioned on the busbar support 310.

An end of the outer material 112 (see FIG. 5) may be formed at a boundary between the electrode lead extension 1202 and the electrode lead terrace 1201. The electrode lead extension 1202 may be electrically insulated. For example, an outer surface of the electrode lead extension 1202 may be formed by an insulating tape.

The electrode lead 120 may include an electrode lead end 1203. The electrode lead end 1203 may extend from the electrode lead extension 1202 and be coupled to the busbar 320. For example, the electrode lead end 1203 may be inserted into the busbar slit 322 (see FIG. 7) of the busbar 320. For example, the electrode lead end 1203 may be welded and coupled to the busbar 320 in the busbar slit 322 (see FIG. 7).

The electrode lead 120 may form two faces. For example, the two faces of the electrode lead 120 may face or be directed toward the direction in which the plurality of battery cells 101 are stacked. For example, the electrode lead 120 may form a front face and a rear face.

A portion of the electrode lead 120 may form a curved surface. A portion of the electrode lead 120 may be bent. For example, the front face of the electrode lead 120 may be concave, and the rear face of the electrode lead 120 may be convex. For example, the front face of the electrode lead 120 may be convex, and the rear face of the electrode lead 120 may be concave.

For example, at least a portion of the electrode lead extension 1202 may form a curved surface or a bent shape. For example, at least a portion of the electrode lead extension 1202 may be convex or concave. Hence, the elasticity of the electrode lead 120 can increase.

The busbar support 310 may form two surfaces. For example, an inner surface of the busbar support 310 may face the battery cell body 110. The inner surface of the busbar support 310 may be spaced apart from the battery cell body 110. An outer surface of the busbar support 310 may face the busbar 320. For example, the outer surface of the busbar support 310 may be coupled to the busbar 320.

A portion of the cooling unit 500 may be positioned between the busbar unit 300 and the battery cell body 110. For example, the cooling leg 420 may be positioned between the busbar unit 300 and the battery cell body 110.

A portion of the cooling unit 500 may be positioned between the electrode leads 120 of two adjacent battery cells 101. For example, the cooling leg 520 may be positioned between the electrode leads 120 of the two adjacent battery cells 101.

The cooling leg 520 may be disposed between the battery cell body 110 and the busbar support 310. For example, the cooling leg 520 may be spaced apart from the battery cell body 110 and the busbar support 310.

For another example, the cooling leg 520 may be connected or coupled to the busbar support 310. For example, the cooling leg 520 may be formed of a polymer material.

For example, the cooling leg 520 and the busbar support 310 may be coupled to each other by an adhesive. For example, the cooling leg 520 and the busbar support 310 may be formed integrally.

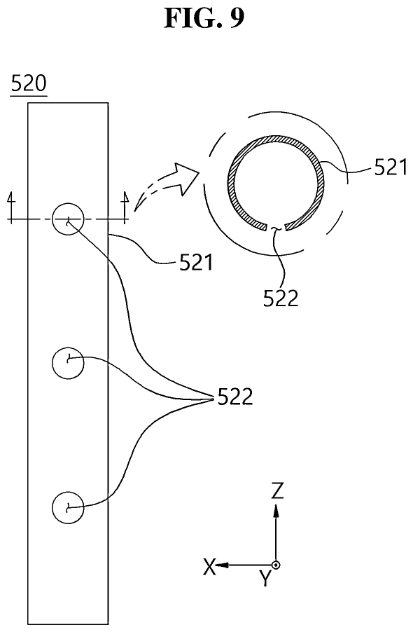

FIG. 9 illustrates a cooling leg according to an embodiment of the present disclosure. In FIG. 9, a cooling leg nozzle 522 provided on the cooling leg 520 may be observed.

Referring to FIG. 9, the cooling leg 520 may include a cooling leg body 521. The cooling leg body 521 may be extended or elongated in one direction. For example, the cooling leg body 521 may extend from the top to the bottom. The cooling leg body 521 may form a hollow portion.

The cooling leg 520 may include a cooling leg nozzle 522. The cooling leg nozzle 522 may be an opening formed in the cooling leg body 521. For another example, the cooling leg nozzle 522 may be a nozzle protruding from an outer surface of the cooling leg body 521.

For example, the cooling leg nozzle 522 may be open toward the battery cell body 110 (see FIG. 8). For example, the cooling leg nozzle 522 may be directed toward or face the battery cell body 110 (see FIG. 8).

For example, the cooling leg nozzle 522 may spray a coolant toward the battery cell body 110 (see FIG. 8). For example, the cooling leg nozzle 522 may spray a liquid coolant toward the battery cell body 110 (see FIG. 8). The liquid coolant may include, for example, a volatile substance.

For example, the cooling leg nozzle 522 may spray a gaseous coolant toward the battery cell body 110 (see FIG. 8). For example, the cooling leg nozzle 522 may spray a nitrogen gas toward the battery cell body 110 (see FIG. 8).

A plurality of cooling leg nozzles 522 may be formed. The plurality of cooling leg nozzles 522 may be arranged along the extended direction of the cooling leg 520. Each of the plurality of cooling leg nozzles 522 may have a different size.

For example, an area of the cooling leg nozzle 522 positioned at an upper portion of the cooling leg body 521 may be larger than an area of the cooling leg nozzle 522 positioned at a lower portion of the cooling leg body 521.

For example, in the two cooling leg nozzles 522 arranged along a longitudinal direction of the cooling leg body 521, an area of the cooling leg nozzle 522 positioned above may be larger than an area of the cooling leg nozzle 522 positioned below. Accordingly, when a fire occurs in the battery cell 101 (see FIG. 3), the coolant can be concentrated on an upper portion of the battery cell 101 (see FIG. 3).

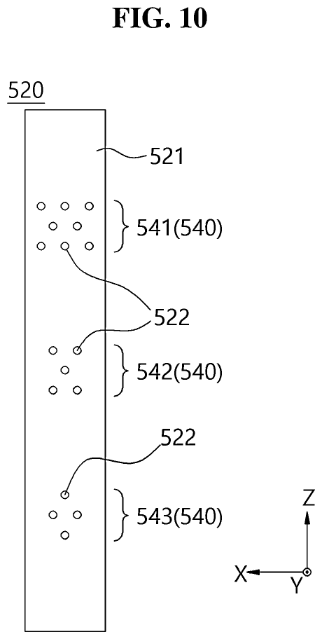

FIG. 10 illustrates a cooling leg with a colling region.

Referring to FIG. 10, the cooling unit 500 may include a cooling region 540. The cooling region 540 may be formed in the cooling leg body 521. For example, the cooling region 540 may include a group of the cooling leg nozzles 522.

A plurality of cooling regions 540 may be provided. For example, the plurality of cooling regions 540 may be formed in one cooling leg body 521. The plurality of cooling regions 540 formed in one cooling leg body 521 may include, for example, a first cooling region 541, a second cooling region 542, and a third cooling region 543.

The first cooling region 541, the second cooling region 542, and the third cooling region 543 may be sequentially arranged downward. For example, the second cooling region 542 may be positioned below the first cooling region 541, and the third cooling region 543 may be positioned below the second cooling region 542. The cooling regions 541, 542 and 543 may have the same area.

A number density of the cooling leg nozzles 522 in the cooling region 540 or a ratio of the area of the cooling leg nozzles 522 to the area of the cooling region 540 may be different in the first cooling region 541, the second cooling region 542, and the third cooling region 543.

For example, the number density of the cooling leg nozzles 522 in the cooling region 540 or the ratio of the area of the cooling leg nozzles 522 to the area of the cooling region 540 may increase in the order of the first cooling region 541, the second cooling region 542, and the third cooling region 543.

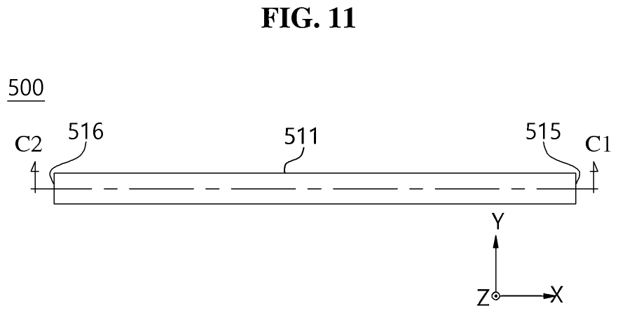

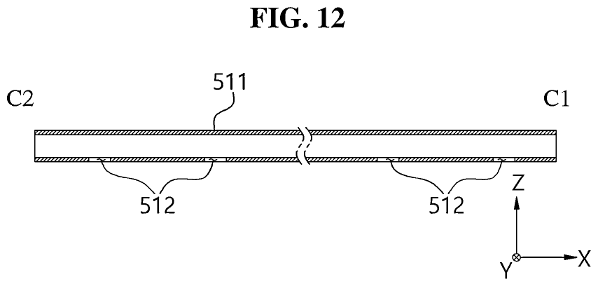

FIG. 11 illustrates a cooling unit in which a nozzle is formed on a cooling bus. FIG. 12 illustrates a cross section of a cooling bus illustrated in FIG. 11 taken along C1-C2.

Referring to FIGS. 11 and 12, the cooling bus 510 may include a cooling bus nozzle 512. The cooling bus nozzle 512 may be formed on the cooling bus body 511. The cooling bus nozzle 512 may be directed toward or face the downward.

The cooling bus nozzle 512 may be an opening formed in the cooling bus body 511. The cooling bus nozzle 512 may be a nozzle protruding from an outer surface of the cooling bus body 511.

The cooling bus 510 provided with the cooling bus nozzle 512 may not include the cooling leg 520 (see FIG. 6). That is, the cooling bus nozzle 512 may spray the coolant between the adjacent battery cells 101 (see FIG. 3).

A plurality of cooling bus nozzles 512 may be provided. For example, the cooling unit 500 may include the plurality of cooling bus nozzles 512. The plurality of cooling bus nozzles 512 may be arranged along the cooling bus body 511.

Each of the plurality of cooling bus nozzles 512 may be directed toward or face two adjacent battery cells 101 (see FIG. 3) corresponding to each nozzle 512. For example, each of the plurality of cooling bus nozzles 512 may be positioned above a space formed between electrode leads 120 (see FIG. 4) of the two corresponding adjacent battery cells 101 (see FIG. 3).

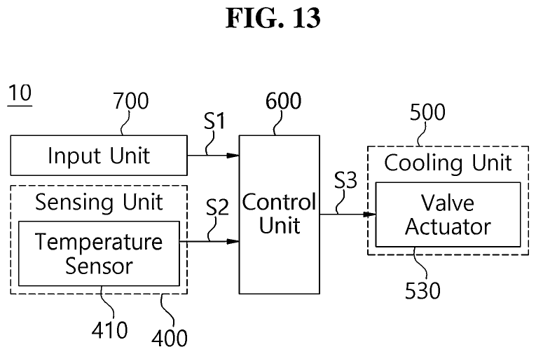

FIG. 13 is a block diagram of a battery module according to an embodiment of the present disclosure.

Referring to FIGS. 1 to 13, the battery module 10 may include a control unit 600. The control unit 600 may perform a calculation. For example, the control unit 600 may process a signal.

The control unit 600 may be implemented through at least one of a central processing unit (CPU), a graphics processing unit (GPU), a processor, an electric circuit, a printed circuit board (PCB), a laptop, a server, or a computer.

The battery module 10 may include an input unit 700. The input unit 700 may obtain an input from a user, etc. The input unit 700 may generate a first signal S1 and transmit the first signal S1 to the control unit 600.

The first signal S1 may include information on the input obtained by the input unit 700. For example, the first signal S1 may include command information on the operation of the battery module 10 or information on a scenario for the operation of the battery module 10.

The battery module 10 may include the sensing unit 400. The sensing unit 400 may include a temperature sensor 410. The temperature sensor 410 may measure a temperature of the battery cell 101. The sensing unit 400 may generate a second signal S2 and transmit the second signal S2 to the control unit 600. The second signal S2 may include information on the temperature of the battery cell 101.

The control unit 600 may generate an output signal S3 based on the input signals S1 and S2. The input signals S1 and S2 may include at least one of the first signal S1 and the second signal S2. The output signal S3 may include a third signal S3. The third signal S3 may include information on the operation of the cooling unit 500.

The cooling unit 500 may include a valve actuator 530. The valve actuator 530 may be connected or coupled to the cooling bus 510. Whether a coolant is introduced into the cooling bus 510 may vary depending on an operation of the valve actuator 530. The valve actuator 530 may operate in response to the third signal S3.

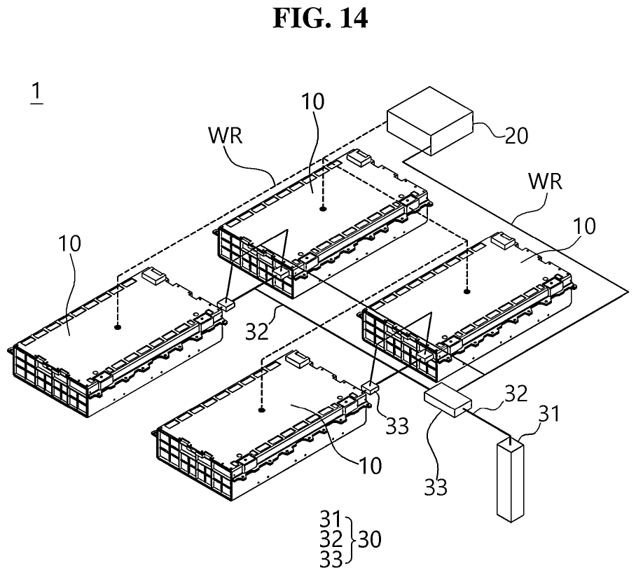

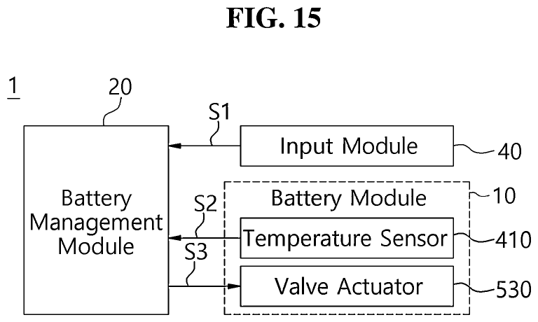

FIG. 14 schematically illustrates a battery pack according to an embodiment of the present disclosure. FIG. 15 is a block diagram of a battery pack according to an embodiment of the present disclosure.

Referring to FIGS. 1 to 15, a battery pack 1 according to an embodiment of the present disclosure may include at least one battery module 10. For example, the battery pack 1 may include a plurality of battery modules 10.

The battery pack 1 according to an embodiment of the present disclosure may include a cooling module 30. The cooling module 30 may include a cooling tank 31. The cooling tank 31 may contain a coolant. For example, the cooling tank 31 may contain liquid nitrogen.

The cooling module 30 may include a cooling feeder 33. The cooling feeder 33 may be connected or coupled to the cooling unit 500 of the battery module 10. For example, the cooling feeder 33 may be connected or coupled to the coolant inlet 515 of the battery module 10. The cooling feeder 33 may include a valve. The cooling feeder 33 may be the valve actuator 530 of the battery module 10.

The cooling module 30 may include a cooling pipe 32. The cooling pipe 32 may connect the cooling tank 31 to the cooling feeders 33. The cooling pipe 32 may connect the plurality of cooling feeders 33. The cooling pipe 32 may connect the cooling feeders 33 to the battery modules 10.

The battery pack 1 according to an embodiment of the present disclosure may include an input module 40. The input module 40 may obtain an input from a user, etc. The input module 40 may generate a first signal S1 and transmit the first signal S1 to a battery management module 20.

The first signal S1 may include information on the input obtained by the input module 40. For example, the first signal S1 may include command information on the operation of the battery pack 1 or information on a scenario for the operation of the battery pack 1.

The battery pack 1 according to an embodiment of the present disclosure may include the battery management module 20. The battery management module 20 may be connected to the battery module 10. For example, the battery management module 20 may be connected to the battery module 10 via a wire WR.

The battery management module 20 may obtain information on a state of the battery module 10. For example, the battery management module 20 may obtain voltage or/and current information of the battery module 10 obtained from the sensing unit 400 of the battery module 10. For example, the battery management module 20 may obtain information on the temperature of the battery module 10 or the temperature of the battery cell 101 through the temperature sensor 410.

The battery management module 20 may control charging and discharging of the battery module 10. For example, the battery management module 20 may control the charging and discharging of the battery module 10 based on the voltage or/and current information of the battery module 10.

The battery module 10 may transmit a second signal S2 including information on the temperature of the battery cell 101 or the temperature of the battery module 10 to the battery management module 20. The second signal S2 may include temperature information obtained by the temperature sensor 410.

The battery management module 20 may generate an output signal S3 based on the input signals S1 and S2. The input signals S1 and S2 may include at least one of the first signal S1 and the second signal S2. The output signal S3 may include a third signal S3. The third signal S3 may include information on the operation of the valve actuator 530.

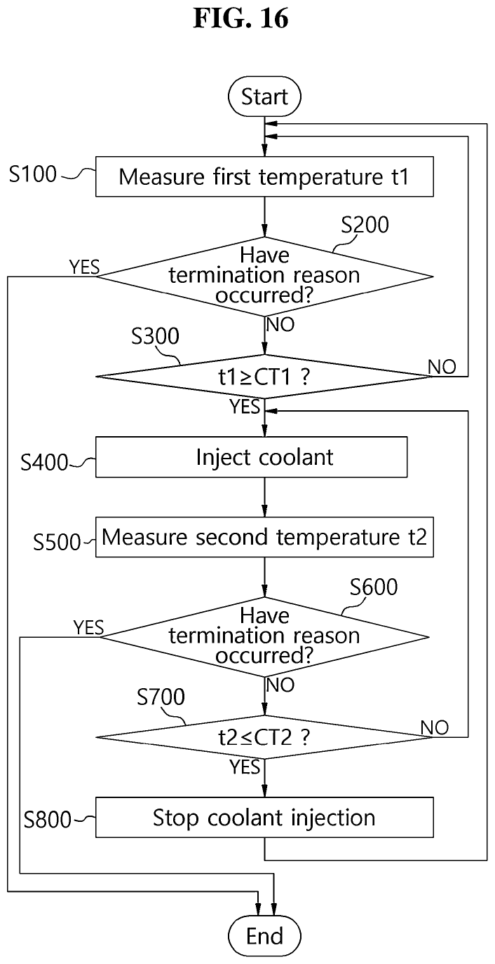

FIG. 16 is a flowchart illustrating a battery cooling method according to an embodiment of the present disclosure.

Referring to FIGS. 1 to 16, a battery cooling method S10 according to an embodiment of the present disclosure may include a step S100 of measuring a first temperature t1. For example, in the step S100, the temperature sensor 410 may measure a temperature of the battery cell 101 or a temperature of the battery module 10. In the step S100, the first temperature t1 may be the temperature of the battery cell 101 or the temperature of the battery module 10 measured by the temperature sensor 410.

The battery cooling method S10 according to an embodiment of the present disclosure may include a step S300 of comparing the first temperature t1 with a first reference temperature CT1. In the step S300, the control unit 600 or the battery management module 20 may determine whether the first temperature t1 is greater than or equal to the first reference temperature CT1. If the first temperature t1 is determined to be less than the first reference temperature CT1, the step S100 of measuring the first temperature t1 may be performed.

The first reference temperature CT1 may be a temperature for determining whether the battery module 10 is overheated. For example, if the first temperature t1 is greater than or equal to the first reference temperature CT1, the battery module 10 may be considered to be overheated. For example, the first reference temperature CT1 may fall within a range of 45 degrees Celsius to 55 degrees Celsius. For example, the first reference temperature CT1 may be 50 degrees Celsius.

The battery cooling method S10 according to an embodiment of the present disclosure may include a step S400 of injecting a coolant. If the first temperature t1 is determined to be greater than or equal to the first reference temperature CT1, the control unit 600 or the battery management module 20 may perform the step S400. In the step S400, the control unit 600 or the battery management module 20 may control the valve actuator 530, and the cooling unit 500 may inject the coolant into the battery cell 101.

The battery cooling method S10 according to an embodiment of the present disclosure may include a step S500 of measuring a second temperature t2. For example, in the step S500, the temperature sensor 410 may measure the temperature of the battery cell 101 or the temperature of the battery module 10. The second temperature t2 may be the temperature of the battery cell 101 or the temperature of the battery module 10 measured by the temperature sensor 410 in the step S500.

In the step S500 of measuring the second temperature t2 and a step S700 of comparing the second temperature t2 with a second reference temperature CT2, the coolant injection step S400 may be continuously performed.

The battery cooling method S10 according to an embodiment of the present disclosure may include the step S700 of comparing the second temperature t2 with the second reference temperature CT2. In the step S700, the control unit 600 or the battery management module 20 may determine whether the second temperature t2 is less than or equal to the second reference temperature CT2. If the second temperature t2 is determined to be higher than the second reference temperature CT2, the coolant injection step S400 may be performed.

The second reference temperature CT2 may be a temperature for determining whether the battery module 10 operates normally. For example, if the second temperature t2 is less than or equal to the second reference temperature CT2, the battery module 10 may be considered normal. For example, the second reference temperature CT2 may fall within a range of 35 degrees Celsius to 45 degrees Celsius. For example, the second reference temperature CT2 may be 40 degrees Celsius.

The battery cooling method S10 according to an embodiment of the present disclosure may include a step S800 of stopping injecting the coolant. If the second temperature t2 is less than or equal to the second reference temperature CT2, the control unit 600 or the battery management module 20 may perform the step S800. That is, if the second temperature t2 is less than or equal to the second reference temperature CT2, the control unit 600 or the battery management module 20 may terminate the coolant injection step S400. The control unit 600 or the battery management module 20 may perform the first temperature measurement step S100 after the step S800.

The battery cooling method S10 according to an embodiment of the present disclosure may include a step S200 of determining whether a first termination reason has occurred. The control unit 600 or the battery management module 20 may perform the step S200 after the first temperature measurement step S100.

In the step S200 of determining whether the first termination reason has occurred, the control unit 600 or the battery management module 20 may determine whether a reason to terminate the battery cooling method S10 has occurred.

If it is determined that the reason to terminate the battery cooling method S10 has occurred, the control unit 600 or the battery management module 20 may terminate the battery cooling method S10.

The battery cooling method S10 according to an embodiment of the present disclosure may include a step S600 of determining whether a second termination reason has occurred. The control unit 600 or the battery management module 20 may perform the step S600 after the second temperature measurement step S500.

In the step S600 of determining whether the second termination reason has occurred, the control unit 600 or the battery management module 20 may determine whether a reason for terminate the battery cooling method S10 has occurred.

If it is determined that the reason to terminate the battery cooling method S10 has occurred, the control unit 600 or the battery management module 20 may terminate the battery cooling method S10.

Only specific examples of implementations of certain embodiments are described. Variations, improvements and enhancements of the disclosed embodiments and other embodiments may be made based on the disclosure of this patent document.

What is claimed is:

1. A battery module comprising:
a battery cell assembly including a plurality of battery cells stacked in a front-rear direction;
a case configured to accommodate the battery cell assembly; and
a cooling unit accommodated in the case, the cooling unit including a cooling bus,
wherein the cooling bus includes a cooling bus body that is accommodated in the case and extends in a direction in which the plurality of battery cells are stacked.

2. The battery module of claim 1, wherein each of the plurality of battery cells includes:
a battery cell body forming a front face and a rear face; and
an electrode lead extending from the battery cell body,
wherein the cooling unit further includes at least one cooling leg including a cooling leg body extending from the cooling bus body and a cooling leg nozzle formed on the cooling leg body, and
wherein the cooling leg body is positioned between the electrode leads of two adjacent battery cells corresponding to the cooling leg body among the plurality of battery cells.

3. The battery module of claim 2, wherein the cooling leg body extends from the cooling bus body in a width direction of the battery cell body.

4. The battery module of claim 2, wherein the cooling leg nozzle is directed toward or faces the battery cell body.

5. The battery module of claim 2, further comprising:
a temperature sensor configured to measure a temperature of at least one of the plurality of battery cells; and
a control unit configured to obtain a temperature information on the temperature from the temperature sensor,
wherein the control unit controls the cooling unit based on the temperature information.

6. The battery module of claim 5, wherein the cooling unit further includes a valve actuator connected to the cooling bus, and
wherein when the temperature based on the temperature information is greater than or equal to a predetermined temperature, the control unit controls the valve actuator to introduce a coolant into the cooling bus body.

7. The battery module of claim 2, further comprising a busbar unit including a busbar coupled to the electrode lead,
wherein the cooling leg body is positioned between the battery cell bodies of the two adjacent battery cells and the busbar unit.

8. The battery module of claim 2, wherein the cooling leg nozzle includes a plurality of cooling leg nozzles that are formed on the cooling leg body and are spaced apart along a longitudinal direction of the cooling leg body, and
wherein sizes of the plurality of cooling leg nozzles decrease as they go away from the cooling bus body.

9. The battery module of claim 8, wherein the cooling bus body is adjacent to a side of the battery cell body, and
wherein the at least one cooling leg extends from the cooling bus body toward another side of the battery cell body.

10. A battery pack comprising:
at least one battery module;
a battery management module connected to the at least one battery module; and
a cooling module including a cooling tank containing a coolant,
wherein the at least one battery module includes:
a battery cell assembly including a plurality of battery cells stacked in a front-rear direction;
a case configured to accommodate the battery cell assembly; and
a cooling unit accommodated in the case, the cooling unit including a cooling bus,
wherein the cooling bus includes a cooling bus body that is accommodated in the case and receives the coolant from the cooling module, and
wherein the cooling bus body extends in a direction in which the plurality of battery cells are stacked.

11. The battery pack of claim 10, wherein each of the plurality of battery cells includes:
a battery cell body forming a front face and a rear face; and
an electrode lead extending from the battery cell body,
wherein the cooling unit further includes at least one cooling leg including a cooling leg body extending from the cooling bus body and a cooling leg nozzle formed on the cooling leg body, and
wherein the cooling leg body is positioned between the electrode leads of two adjacent battery cells corresponding to the cooling leg body among the plurality of battery cells.

12. The battery pack of claim 11, wherein the cooling leg body extends from the cooling bus body in a width direction of the battery cell body.

13. The battery pack of claim 11, wherein the cooling leg nozzle is directed toward or faces the battery cell body.

14. The battery pack of claim 11, wherein each of the at least one battery module further includes a temperature sensor configured to measure a temperature of at least one of the plurality of battery cells,
wherein the battery management module obtains a temperature information on the temperature from the temperature sensor and controls the cooling unit based on the temperature information.

15. The battery pack of claim 14, wherein the cooling unit further includes a valve actuator connected to the cooling bus, and
wherein when the temperature based on the temperature information is greater than or equal to a predetermined temperature, the battery management module controls the valve actuator to introduce the coolant into the cooling bus body.

16. The battery pack of claim 11, wherein each of the at least one battery module further includes a busbar unit including a busbar coupled to the electrode lead, and
wherein the cooling leg body is positioned between the battery cell bodies of the two adjacent battery cells and the busbar unit.

17. The battery pack of claim 11, wherein the cooling leg nozzle includes a plurality of cooling leg nozzles that are formed on the cooling leg body and are spaced apart along a longitudinal direction of the cooling leg body, and
wherein sizes of the plurality of cooling leg nozzles decrease as they go away from the cooling bus body.

18. The battery pack of claim 17, wherein the cooling bus body is adjacent to a side of the battery cell body, and
wherein the at least one cooling leg extends from the cooling bus body toward another side of the battery cell body.

19. A battery cooling method of cooling a plurality of battery cells, the battery cooling method comprising:
measuring a first temperature of the plurality of battery cells;
comparing the first temperature with a first reference temperature;
when the first temperature is greater than or equal to the first reference temperature, injecting a coolant into the plurality of battery cells;
measuring a second temperature of the plurality of battery cells;
comparing the second temperature with a second reference temperature; and
stopping injecting the coolant when the second temperature is less than or equal to the second reference temperature.

20. The battery cooling method of claim 19, wherein when the first temperature is less than the first reference temperature, measuring the first temperature is performed,
wherein when the second temperature is higher than the second reference temperature, injecting the coolant is performed, and
wherein the first reference temperature is higher than the second reference temperature.
